(19) United States
(12) Patent Application Publication
(10) Pub. No.: US 2004/0010711 A1
(43) Pub. Date: Jan. 15, 2004

(54) Secure communications and control in a fueling environment

(76) Inventors: Weiming Tang, Round Rock, TX (US); Steve Mixon, Painted Post, NY (US)

Correspondence Address: FISH & RICHARDSON P.C., 5000 BANK ONE CENTER, 1717 MAIN STREET, DALLAS, TX, 75201, US

(21) Appl. No.: 10/192,668

(22) Filed: Jul. 10, 2002

(51) Int. Cl. H04L 9/00

(52) U.S. Cl. 713/201

(57) ABSTRACT

A method and system for secure communication and control in a fueling environment. In one aspect of the present invention, user data is received at a first node associated with a fuel dispenser, encrypted using a public cryptography key, and transmitted to a second node. The second node decrypts the encrypted user data using a private cryptography key associated with the public cryptography key. In another aspect of the present invention, a first message is received at a first node. The first node generates pseudo-random data in response to the first message, encrypts the pseudo-random data using a public cryptography key, and transmits the encrypted pseudo-random data to a second node. The second node decrypts the data using a private cryptography key and transmits the decrypted data to the first node. The first node validates the decrypted data, and processes the first message if the data is valid.

### TECHNICAL FIELD OF THE INVENTION

The present invention relates to a system and method for secure communications in a fueling environment, and more particularly, to the use of public-key/private-key encryption to encrypt communication and control messages transmitted between systems within a fueling environment.

### BACKGROUND OF THE INVENTION

In recent years traditional service stations have evolved into elaborate point-of-sale (POS) facilities providing a wide variety of customer services, such as fuel dispensing, car washing, ATM access, money order access, and credit card or debit card transactions at the fueling environment.

In a traditional fueling environment, card data supplied from a user purchasing fuel or other products and services is transmitted in an unprotected form from the dispenser at the forecourt to the point-of-sale (POS) system, and from the POS system to a network host which performs authentication of the card data. This allows unauthorized parties to easily intercept user card data by tampering with the transmission line, especially if the transmission line is Ethernet or a satellite link.

Although systems exist to secure a special tag or debit pin number using special key management in the dispenser, these systems require special hardware to prevent key tampering at the dispenser through the use of local key management. The special hardware is very costly and difficult to maintain. For example, in order to support a debit card, the dispenser needs to have a special secured pin pad, such as a Tamper Resist Security Module (TRSM) that requires special procedures to install and configure. In addition, these systems require special procedures to dispose of the pin pad when it needs to be replaced because once the key is disclosed, the pin number is no longer secured.

In recent years, it has become desirable in the fueling environment to offer advertisements and additional sales to customers from third party vendors. However, traditionally there has not been a method available to secure user card data information at the dispenser from the third party system.

In current fueling environments, there does not exist a way to secure communication control messages between systems in the fueling environment. In current fueling environments, a proprietary protocol is used to communicate among systems. If the protocol is obtained by an unauthorized user, the unauthorized user can take over control of the dispenser system. This can lead to potential fraud, such as the obtaining of fuel without payment, or the theft of customer card data. The introduction of third party services within the fueling environment introduces an additional potential for unauthorized control of the dispenser system or POS system.

### SUMMARY OF THE INVENTION

The present invention provides for a method and system for secured communication to protect user card data transmitted from a point-of-sale (POS) or dispenser system of a fueling environment using public-key/private-key encryption. In addition, the present invention provides a method and system to secure control of a dispenser system in a fueling environment through the use of public-key/private-key encryption.

In one aspect of the present invention, a system and method for secure communication within a fueling environment includes receiving user data at a first node associated with a fuel dispenser, encrypting the user data using a public cryptography key, and transmitting the encrypted user data. The encrypted user data is received at a second node and decrypted using a private cryptography key associated with the public cryptography key.

In another aspect of the present invention, a system and method for secure communication and control within a fueling environment includes receiving a first message at a first node associated with a fuel dispenser, generating pseudo-random data in response to the first message, encrypting the generated pseudo-random data using a public cryptography key, and transmitting the encrypted generated pseudo-random data. A second node receives the encrypted generated data from the first node, decrypts the encrypted generated pseudo-random data using a private cryptography key associated with the public cryptography key, and transmits the decrypted generated pseudo-random data to the first node. The first node is further adapted to receive the decrypted generated pseudo-random data from the second node, validate the decrypted generated pseudo-random data, and process the first message if the decrypted generated pseudo-random data is valid.

### BRIEF DESCRIPTION OF THE DRAWINGS

A more complete understanding of the system, method and apparatus of the present invention may be had by reference to the following Detailed Description when taken in conjunction with the accompanying Drawings wherein:

FIG. 1 illustrates a block diagram of a secured user data communication system 100 for use in a fueling environment in accordance with one embodiment of the present invention;

FIG. 2 illustrates a method for providing a secured credit card fueling transaction in accordance with the secured user data communication system 100 of FIG. 1;

FIG. 3 illustrates another method for providing a secured credit card fueling transaction in accordance with the secured user data communication system 100 of FIG. 1;

FIG. 4 illustrates still another method for providing a secured credit card fueling transaction in accordance with the secured user data communication system 100 of FIG. 1;

FIG. 5 is a block diagram of a secured user data communication system 500 for use in a fueling environment in accordance with another embodiment of the present invention;

FIG. 6 illustrates a method for providing a secured credit card fueling transaction in accordance with the secured user data communication system 500 of FIG. 5;

FIG. 7 is a block diagram of a secured data communication system 700 for use in a fueling environment in accordance with another embodiment of the present invention;

FIG. 8 illustrates a method for providing a secured fueling transaction in accordance with the secured data communication system 700 of FIG. 7;

FIG. 9 illustrates a method for providing a secured third party transaction in accordance with the secured data communication system 700 of FIG. 7; and

FIG. 10 illustrates a method for providing secured service in accordance with the secured data communication system 700 of FIG. 7.

### DETAILED DESCRIPTION OF THE INVENTION

The present invention is generally directed to the use of public key/private key encryption in a fueling environment. Public key/private key encryption provides for the capability of encrypting a message using a public key which can only be decrypted by someone possessing a private key associated with the pubic key. A popular public key/private key encryption algorithm is the RSA public-key cryptography system developed by Ronald L. Rivest, Adi Shamir, and Leonard M. Adleman in 1977. The challenge of public-key cryptography is developing a system in which it is extremely difficult to determine the private key. This is accomplished through the use of a one-way function. Using a one-way function it is relatively easy to compute a result given some initial input values. However, it is extremely difficult to determine the original values starting with the result. In mathematical terms, given a value x, computing f(x) is relatively easy. However, given the result f(x), computing x is very difficult. The one-way function used in the RSA algorithm is a multiplication of prime numbers. It is mathematically simple to multiply two large prime numbers, however it is extremely time-consuming to factor them for most very large primes. Public-key cryptography makes use of this property of large prime numbers by implementing a system that uses two large primes to build a private key, and the product of the primes to build a public key. A simplified example of the RSA algorithm is described as follows:

Key Generation

By selecting two primes, P=11 and Q=23, the RSA algorithm is used to generate the numbers N, E, and D in the following manner:

N=P×Q=11×23=253

PHI=(P−1)(Q−1)=220

The public exponent E is calculated so that the greater common divisor of E and PHI is 1. In other words, E is relatively prime with PHI. For this example:

E=3

In the RSA algorithm, N and E are used as the public keys. The private key D is the inverse of E modulo PHI. By using an extended Euclidian algorithm, the private key is determined as D=147.

Encryption

To encrypt data, for example a number M=4, the following procedure is used to form an encrypted message C:

C=M\hat{ }E mod N=4\hat{ }3 mod 253=64

Thus, the encrypted message is 64.

Decryption

The encrypted message will be decrypted to form a decrypted message M from the encrypted message C using the following procedure:

M=C\hat{ }D mod N=64\hat{ }147 mode 253=4

thereby recovering the original message data.

Although the above example used small prime numbers for illustrative purposes, in actual practice the prime numbers selected for public key/private key cryptography are very large numbers, for example 128-bit or 256-bit prime numbers.

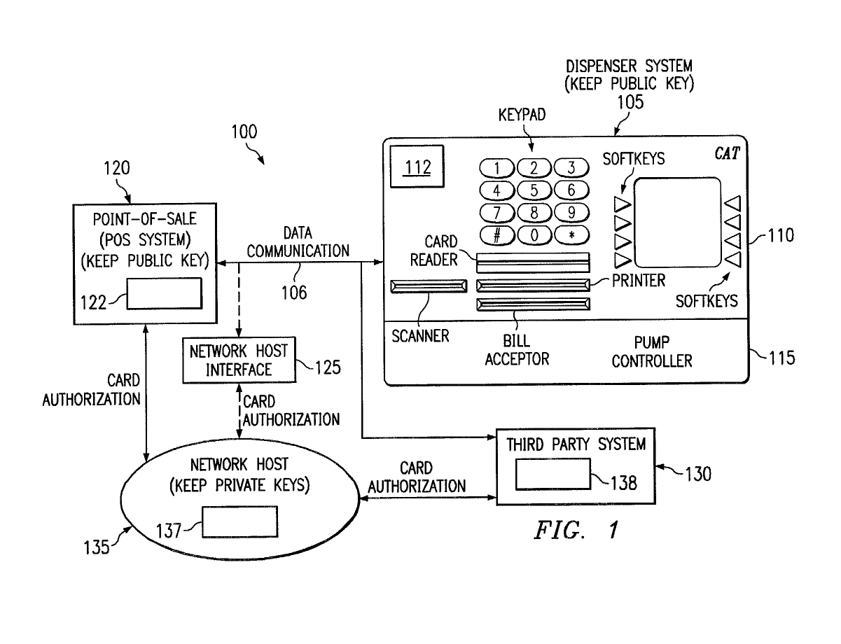

Referring to FIG. 1, a block diagram of a secured user data communication system 100 for use in a fueling environment in accordance with one embodiment of the present invention is illustrated. The communication system 100 includes a dispenser system 105 connected, using a data communication line 106, to a point-of-sale (POS) system 120, a network host interface 125, if necessary, and a third party system 130. A network host 135, preferably a remote network host, is in communication with the POS system 120, the network host interface 125, and the third party system 130 using a communication network, such as an Ethernet, satellite network, optical fiber network, telephone network, a serial link, a controller area network (CAN), etc. The network host 135 is used to authorize customer transactions conducted at the dispenser system 105 or POS system 120 in the fueling environment. The network host interface 125 is used, if necessary, to interface the fueling environment with the network host 135.

The dispenser system 105 includes a customer access terminal (CAT) 110 which is used to connect with various customer access interfaces such as a keypad, card reader, scanner, bill acceptor, printer, display screen, soft keys, etc., and a pump controller 115 which is used to control the hydraulics of the dispenser system 105 to dispense fuel to customers.

The POS system 120 is typically located inside the fueling environment store and functions as a dispenser control system to authorize customer transactions, such as fueling at the dispenser system 105, use of a car wash, or merchant transactions within the store. In accordance with the current embodiment of the invention, the CAT 110 and POS system 120 both maintain at least one public key to be used for the encryption of transmitted data, such as user credit card data, to be sent to the network host 135 for authorization of the current customer transaction. The network host 135 uses at least one private key maintained at the network host 135 to decrypt the received data and send an authorization message to the CAT 110 or POS system 120 if the customer transaction is authorized.

The dispenser system 105 and POS system 120 can each include a corresponding dispenser control library 112, 122 including software instructions for maintaining the public keys and performing the procedures of the present invention. Additionally, the network host 135 can include a dispenser control library 137 including software instructions for maintaining the private keys and performing the procedures of the present invention. Through the installation of dispenser control libraries into the various systems and components of the fueling environment, the present invention can be implemented in a manner that is transparent to existing fueling systems. As a result, the dispenser control library not only enhances the security of existing systems, but also reduces the cost of updating to new systems.

An authenticated third party system 130 can be plugged into the data communication line between the dispenser system 105 and the POS system 120 to deliver additional services, such as advertising content or sale offers for additional merchandise, to a customer during a fueling session. In order to authorize an additional sale, the third party system 130 receives encrypted card data from the dispenser system 105 and provides it to the network host 135 for authorization. The third party system 130 can optionally include a software library 138 that contains software instructions and data for interacting with the dispenser system 105 and POS system 120, without the necessity to contain public key/private key encryption information. Although the third party system 130 is illustrated in FIG. 1 as using the same network host 135 for transaction authorization as the POS system 120, it should be understood that the third party system 130 and POS system 120 can each be connected to separate network hosts that perform authorization procedures independently from one another.

The use of a public key for encryption of user card data in the fueling environment and a private key for validation of the encrypted user card data in a network host 135 provides for a number of advantages over traditional methods. Through the use of a public/private key algorithm, the dispenser system 105 or POS system 120 at the fueling environment receives user card data, encrypts the user card data using the public key, and sends the encrypted data to the network host 135. The encrypted user card data can only be decrypted using a private key maintained at the network host 135. Thus, the card data is resistant to interception by undesirable parties even if the data communication line between components in the fueling environment, or the network between the fueling environment and the network host 135 is tampered with or compromised. The public key stored in the fueling environment does not have to be protected since the encrypted information cannot be decrypted without obtaining the private key stored in the network host 135.

An additional advantage of the current embodiment of the present invention is that user card data can be secured from the third party system 130, as the third party system 130 does not need to maintain any private keys in order for a transaction to be authorized by the network host 135.

The public/private key encryption of the present invention can also be applied to pin number encryption, such as that used with a debit card pin number. The installation of a special secured pin pad in the dispenser, such as a Tamper Resist Security Module (TRSM) and local key management is no longer necessary, thus eliminating the special procedures required for installation, maintenance, and disposal. If a bank desires to implement the public-key/private-key solution of the present invention, the bank can issue a public key to each pin pad module in the fueling environment. The pin pad module can store the public key and encrypt the pin number using the public key. The pin pad can then send the encrypted pin number through the CAT system and/or POS system to the remote network host associated with the bank. The remote network host can then decrypt the number with its own private key. Thus, only the bank that issues the public key is able to decrypt the encrypted data even if the public key is acquired by an unauthorized party.

In an alternate embodiment of the communication system of FIG. 1, the public/private keys used for encryption can be updated periodically to provide for greater security. For example, an initial private key can be stored at the network host 135, and a corresponding initial public key stored at the CAT 110. Once communication between the network host 135 and the CAT 110 is established, the network host 135 periodically generates or selects a new private key/public key pair. The new public key corresponding to the new private key is encrypted by the network host 135 using the old private key, and transmitted as an encrypted message to the CAT 110. The CAT 135 then decrypts the encrypted message using the old public key to obtain the new public key, and sends an acknowledgment to the network host 135.

Further communication between the network host 135 and the CAT 110 is performed using the new public key/private key pair until a new pair is selected by the network host 135. In a similar manner, the network host 135 can update the private key/public key pair used for communication between the network host 135 and the CAT 110. Periodically updating the private key/public key pair provides for protection against tampering because even if the current private key has been compromised it will be soon be changed.

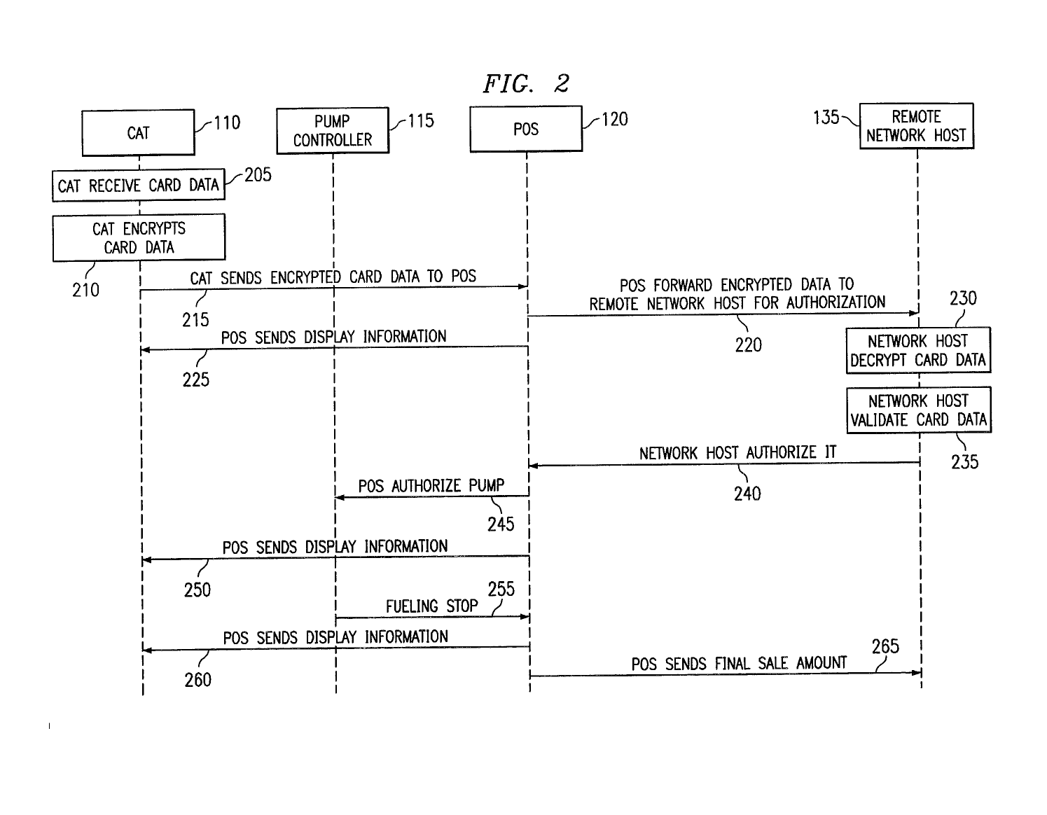

Referring now to FIG. 2, there is illustrated a method for providing a secured credit card fueling transaction in accordance with the secured user data communication system 100 of FIG. 1. In step 205, the CAT 110 receives credit card data from a customer initiating a fueling transaction at the dispenser system 105, i.e. a pay-outside credit card transaction. In step 210, the CAT 110 encrypts the card data using a public key and sends the encrypted card data to the POS system 120 (step 215). In step 220, the POS system 120 forwards the encrypted card data to a remote network host 135 for authorization. In step 225, the POS system 120 sends display information to the CAT 110 to provide the customer with a message indicating that authorization is in progress. In step 230, the remote network host 135 uses a private key to decrypt the received encrypted card data. The remote network host 135 validates the decrypted card data (step 235), and sends an authorization message to the POS system 120 if the card data has been authorized (step 240).

Upon receiving authorization from the remote network host 135, the POS system 120 sends a pump authorization message to pump controller 115 (step 245), and sends display information to the CAT 110 to indicate to the customer that fueling can begin (Step 250). After completion of fueling by the customer, the pump controller 115 sends a fueling stop message to the POS system 120 (step 255). The POS system 120 sends display information to the CAT 110 indicating the final sale amount to the customer (step 260). The POS system 120 also sends a message to the remote network host 135 indicating the final amount of the sale (step 265).

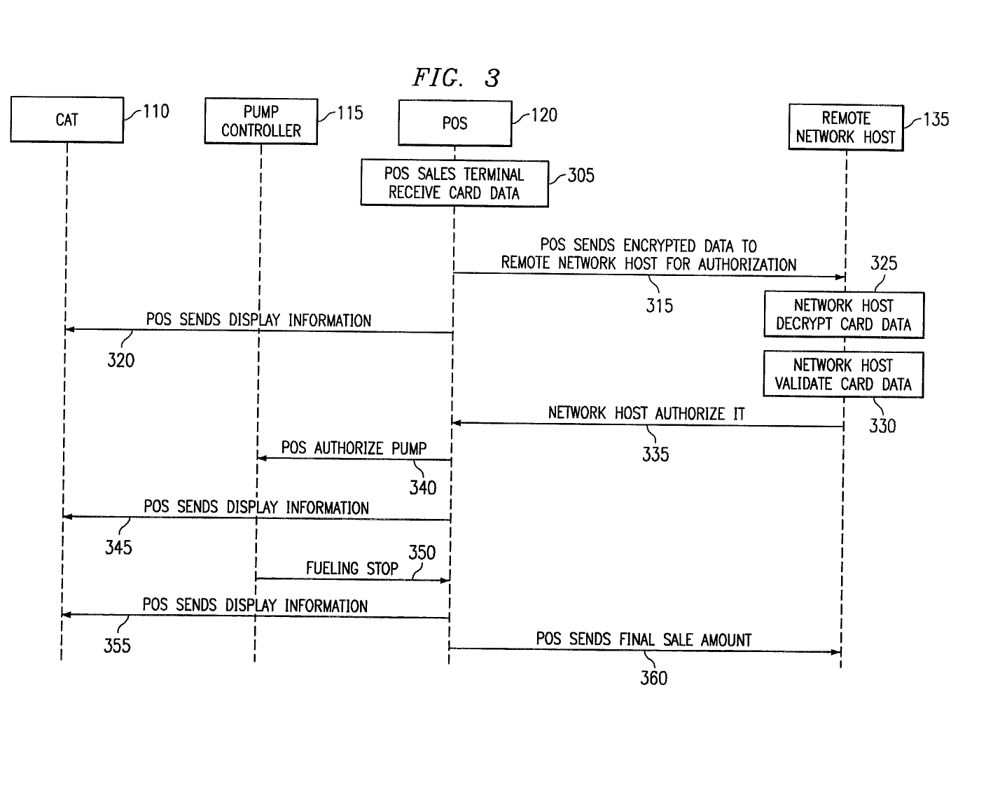

Referring now to FIG. 3, there is illustrated another method for providing a secured credit card fueling transaction in accordance with the secured user data communication system 100 of FIG. 1. In step 305, the POS system 120 receives credit card data from a customer initiating a fueling transaction using a sales terminal at the POS system 120, i.e. a pay-inside credit card transaction. In step 310, the POS system 120 encrypts the card data using a public key and sends the encrypted card data to the remote network host 135 for authorization (step 315). In step 320, the POS system 120 sends display information to the CAT 110 to provide the customer with a message indicating that authorization is in progress. In step 325, the remote network host 135 uses a private key to decrypt the encrypted card data. The remote network host 135 validates the card data (step 330), and sends an authorization message to the POS system 120 if the card data has been authorized (step 335).

Upon receiving authorization from the remote network host 135, the POS system 120 sends a pump authorization message to pump controller 115 (step 340), and sends display information to the CAT 110 indicating to the customer that fueling can begin (step 345). After completion of fueling by the customer, the pump controller 115 sends a fueling stop message to the POS system 120 (step 350). The POS system 120 sends display information to the CAT 110 indicating the final sale amount to the customer (step 355). The POS system 120 also sends a message to the remote network host 135 indicating the final amount of the sale (step 360).

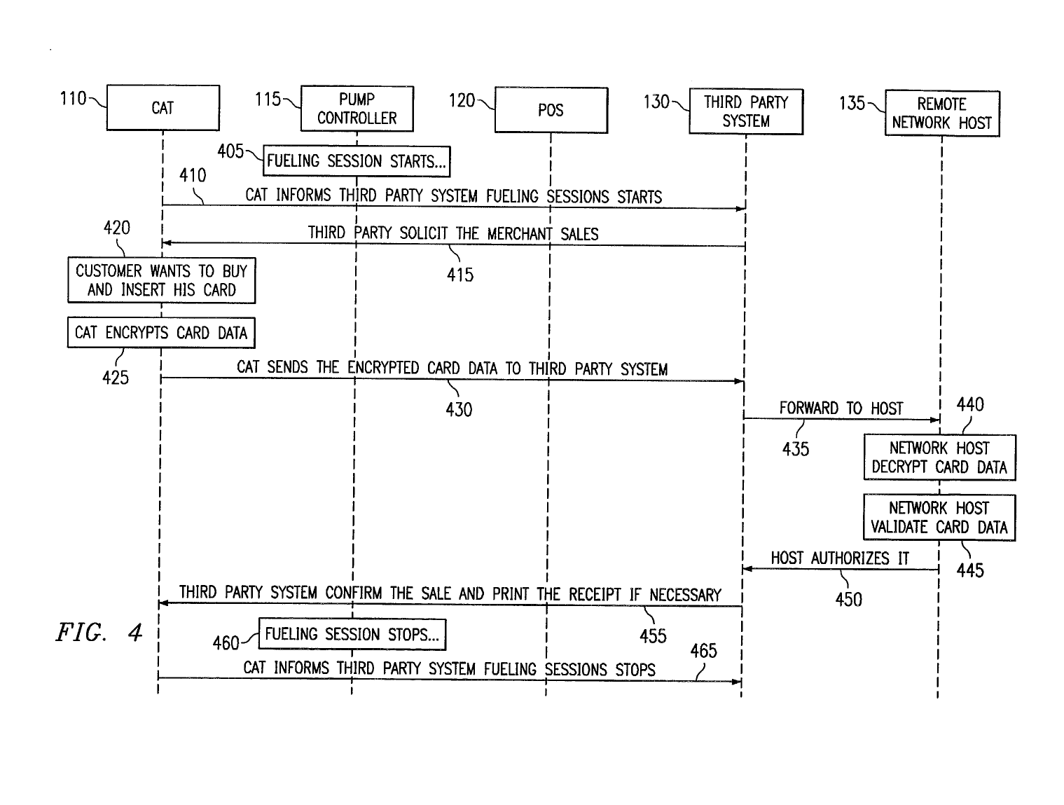

Referring now to FIG. 4, there is illustrated still another method for providing a secured credit card fueling transaction in accordance with the secured user data communication system 100 of FIG. 1. In step 405, a customer initiates a fueling transaction at the dispenser system 105. In step 410, the CAT 110 sends a message to the third party system 130 indicating that a fueling session has started. In step 415, the third party system 130 sends a solicitation message to the CAT 110 to display offers for additional purchase to the customer. If the customer wishes to purchase the solicited sale, the customer inserts a credit card into the CAT 110 to provide card data (step 420). In step 425, the CAT 110 encrypts the card data using a public key and sends the encrypted card data to the third party system 130 (step 430).

In step 435, the third party system 130 forwards the encrypted card data to the remote network host 135 for authorization. In step 440, the remote network host 135 uses a private key to decrypt the encrypted card data. The remote network host 135 validates the card data (step 445), and sends an authorization message to the third party system 130 if the card data has been authorized (step 450).

Upon receiving authorization from the remote network host 135, the third party system 130 sends a message to the CAT 110 to indicate to the customer that the sale has been confirmed and to print a receipt if necessary (step 455). After completion of the fueling session by the customer (step 460), the CAT 110 sends a message to the third party system 130 indicating that the fueling session has stopped (step 465).

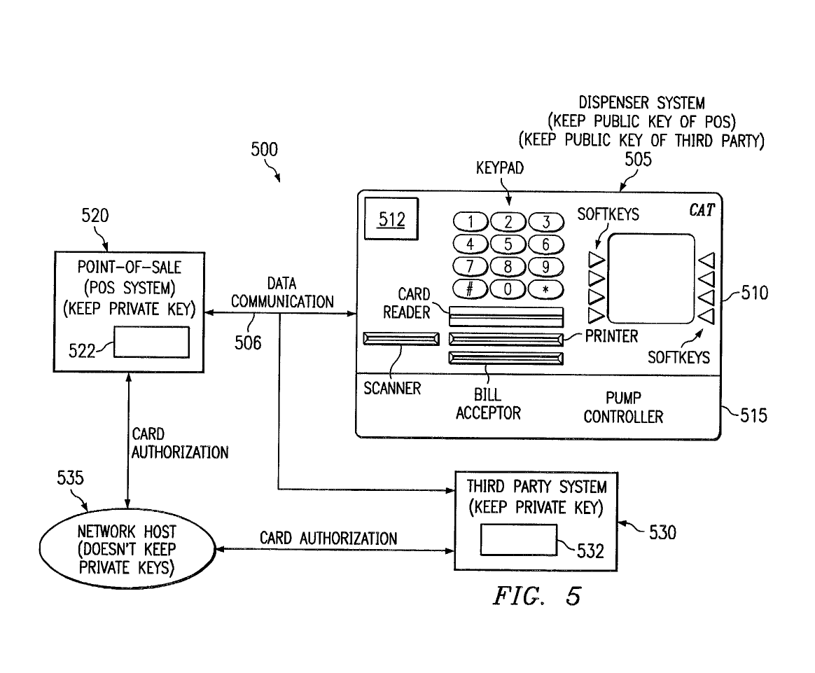

Referring now to FIG. 5, a block diagram of a secured user data communication system 500 for use in a fueling environment in accordance with another embodiment of the present invention is illustrated. The communication system 500 includes a dispenser system 505, including a CAT 510 and pump controller 515, connected, using a communication line 506, to a point-of-sale (POS) system 520 and a third party system 530. A network host 535, preferably a remote network host, is in communication with the POS system 520 and the third party system 530 using a communication network, such as an Ethernet, satellite network, optical fiber network, telephone network, a serial link, a controller area network (CAN), etc. In the embodiment of FIG. 5, the network host 535 performs card authentication but is not required to maintain any private keys.

In the communication system of FIG. 5, the CAT 510 keeps separate public keys associated with the POS system 520 and the third party system 530 for the encryption of user card data, such as credit card data. The POS system 520 and third party system 530 each maintain their own private keys for the decryption of encrypted credit card data received from the CAT 510. The dispenser system 505 can include a dispenser control library 512 including software instructions for maintaining the public keys and performing the procedures of the present invention. Additionally, the POS system 520 and third party system 530 can each include a corresponding dispenser control library 522, 532 including software instructions for maintaining the private keys and performing the procedures of the present invention. In addition, the private keys can be stored in tamper resistant hardware.

When the CAT 510 sends credit card data to the POS system 520, the CAT 510 encrypts the card data using the public key associated with the POS system 520. After receiving the encrypted card data, the POS system 520 decrypts the card data using its private key and sends the card data to the remote network host 525 for authentication.

Similarly, when the CAT 510 sends credit card data to the third party system 530, the CAT 510 encrypts the card data using the public key associated with the third party system 530. After receiving the encrypted card data, the third party system 530 decrypts the card data using its private key and sends the card data to the remote network host 525 for authentication. Since the POS system 520 and third party system 530 each keep their own unique private key, each cannot decrypt card data that is intended for the other, thus enhancing card data security. Although the third party system 530 is illustrated in FIG. 5 as using the same network host 535 for transaction authorization as the POS system 520, it should be understood that the third party system 530 and POS system 520 can each be connected to separate network hosts that perform authorization procedures independently from one another.

The communication system of FIG. 5 is particularly useful if the remote network host to which the fueling environment is connected does not support the maintaining of private keys. The POS system 520 and the third party system 530 can each maintain their own private keys whose associated public keys can be loaded into the dispenser system 505. In this way, card data being transferred on a local transmission line within the fueling environment can be protected against tampering.

In an alternate embodiment of the communication system of FIG. 5, the public/private keys used for encryption can be updated periodically to provide for greater security. For example, an initial private key can be stored at the POS system 520, and a corresponding initial public key stored at the CAT 510. Once communication between the POS system 520 and the CAT 510 is established, the POS system 520 periodically generates or selects a new private key/public key pair. The new public key corresponding to the new private key is encrypted by the POS system 520 using the old private key, and transmitted as an encrypted message to the CAT 510. The CAT 510 then decrypts the encrypted message using the old public key to obtain the new public key, and sends an acknowledgment to the POS system 520.

Further communication between the POS system 520 and the CAT 510 is performed using the new public key/private key pair until a new pair is selected by the POS system 520. In a similar manner, the third party system 530 can update the private key/public key pair used for communication between the third party system 530 and the CAT 510. Periodically updating the private key/public key pair provides for protection against tampering because even if the current private key has been compromised it will be soon be changed.

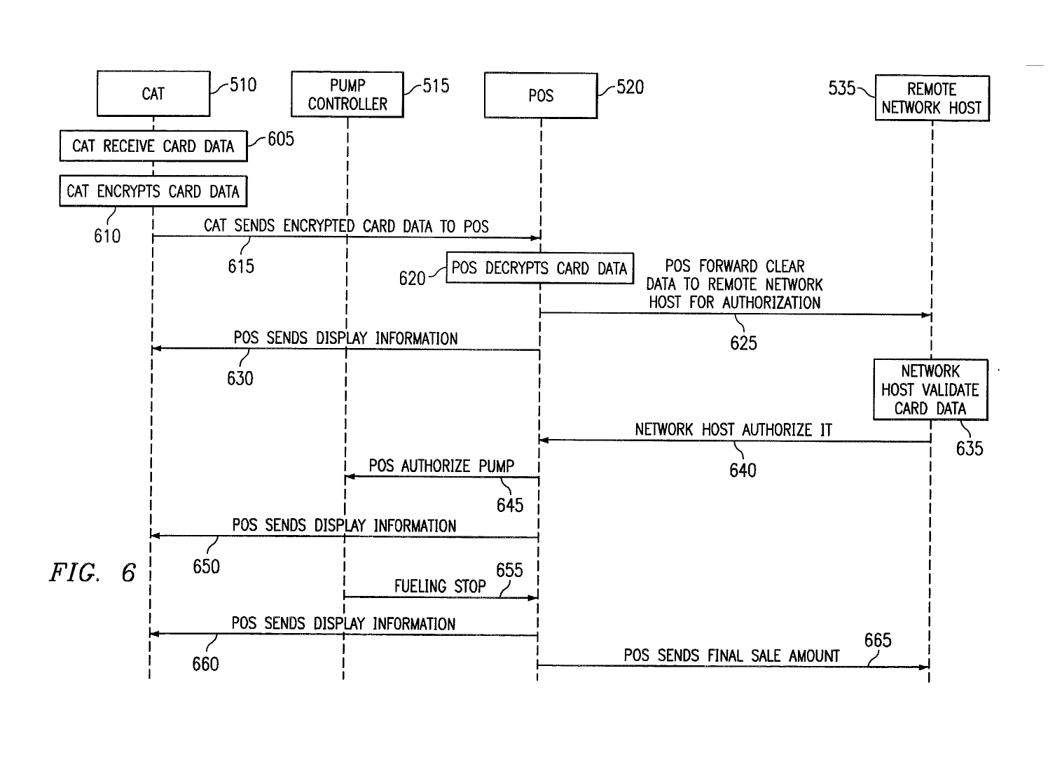

Referring now to FIG. 6 there is illustrated a method for providing a secured credit card fueling transaction in accordance with the secured user data communication system 500 of FIG. 5. In step 605, the CAT 510 receives credit card data from a customer initiating a fueling transaction at the dispenser system 505. In step 610, the CAT 510 encrypts the card data using a public key associated with the POS system 520, and sends the encrypted card data to the POS system 520 (step 615). In step 620, the POS system 520 decrypts the card data using its private key and forwards the encrypted card data to a remote network host 535 for authorization (step 625). In step 630, the POS system 520 sends display information to the CAT 510 to provide the customer with a message indicating that authorization is in progress. The remote network host 135 validates the card data (step 635), and sends an authorization message to the POS system 520 if the card data has been authorized (step 640).

Upon receiving authorization from the remote network host 535, the POS system 520 sends a pump authorization message to pump controller 515 (step 645), and sends display information to the CAT 510 indicating to the customer that fueling can begin (Step 650). After completion of fueling by the customer, the pump controller 515 sends a fueling stop message to the POS system 520 (step 655). The POS system 520 sends display information to the CAT 510 indicating the final sale amount to the customer (step 660). In addition, the POS system 520 sends a message to the remote network host 535 indicating the final amount of the sale (step 665).

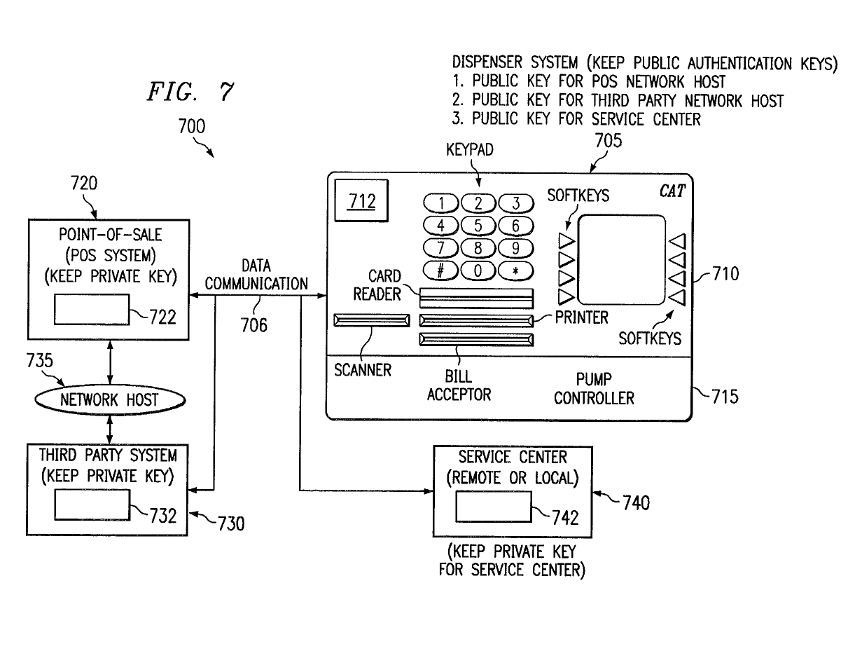

Referring now to FIG. 7, a block diagram of a secured data communication system 700 for use in a fueling environment in accordance with another embodiment of the present invention is illustrated. In accordance with the current embodiment, a dispenser control protocol is secured using public-key/private key encryption to ensure that a dispenser system can only accept commands from trusted sources. The communication system 700 includes a dispenser system 705, including a CAT 710 and pump controller 515, connected, using a data communication line 706, to a point-of-sale (POS) system 720, a third party system 730, and a service center 740. The service center 740 can be a remote or local service center for sending service request commands to the dispenser system 705. The POS system 720 and third party system 730 are in communication with a remote network host 735 using a communication network, such as an Ethernet or satellite network, to provide authorization for customer credit card transactions.

In accordance with the current embodiment of the invention, the dispenser system 705 maintains separate public authentication keys associated with each of the POS system 720, the third party system 730, and the service center 740. The POS system 720, the third party system 730, and the service center 740 each maintain a separate private key associated with the respective keys maintained by the dispenser system 705. By using public key/private key encryption, POS commands cannot be sent without the POS system's 720 private key, even if the protocol is known to the sender. Similarly the third party system 730 and service center 740 can only send commands to the dispenser system 705. Although the third party system 730 is illustrated in FIG. 7 as using the same network host 735 for transaction authorization as the POS system 720, it should be understood that the third party system 730 and POS system 720 can each be connected to separate network hosts that perform authorization procedures independently from one another.

The dispenser system 705 can include a dispenser control library 712 including software instructions for maintaining the public keys and performing the procedures of the present invention. Additionally, the POS system 720, the third party system 730, and the service center 740 can each include a corresponding dispenser control library 722, 732, and 742 including software instructions for maintaining the private keys and performing the procedures of the present invention. In addition, the private keys can be stored in tamper resistant hardware.

In an alternate embodiment of the communication system of FIG. 7, the public/private keys used for encryption can be updated periodically to provide for greater security. For example, an initial private key can be stored at the POS system 720, and a corresponding initial public key stored at the dispenser system 705. Once communication between the POS system 720 and the dispenser system 705 is established, the POS system 720 periodically generates or selects a new private key/public key pair. The new public key corresponding to the new private key is encrypted by the POS system 720 using the old private key, and transmitted as an encrypted message to the dispenser system 705. The dispenser system 705 then decrypts the encrypted message using the old public key to obtain the new public key, and sends an acknowledgment to the POS system 720.

Further communication between the POS system 720 and the dispenser system 705 is performed using the new public key/private key pair until a new pair is selected by the POS system 720. In a similar manner, the third party system 730 can update the private key/public key pair used for communication between the third party system 730 and the dispenser system 705. Similarly, the service center 740 can update the public key/public key pair used for communication between the service center 740 and the dispenser system 705. Periodically updating the private key/public key pair provides for protection against tampering because even if the current private key has been compromised it will be soon be changed.

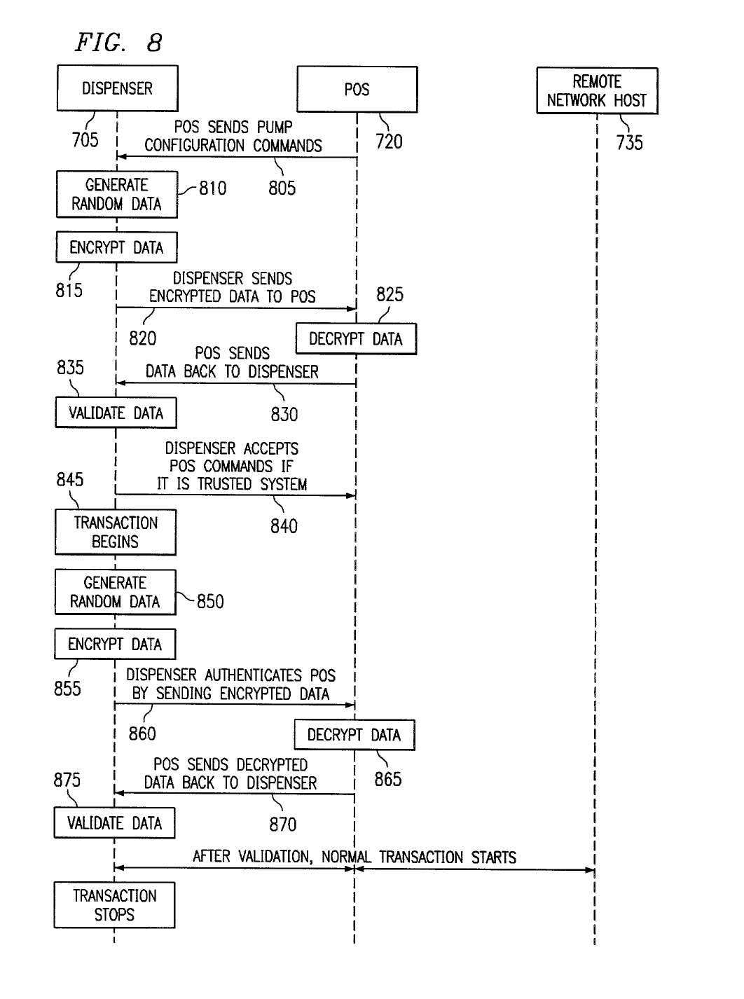

Referring now to FIG. 8, there is illustrated a method for providing a secured fueling transaction in accordance with the secured data communication system 700 of FIG. 7. In step 805, the POS system 720 sends pump configuration commands to the dispenser system 705. After receiving the pump configuration commands from the POS system 720, the dispenser system 705 generates random or pseudo-random data based upon the current time, time related data, or other unique data that cannot be predicated (step 810). The dispenser system 705 encrypts the generated data using the public key associated with the POS system 720 (step 815) and sends the encrypted data to the POS system 720 for authentication (step 820). In step 825, the POS system 720 decrypts the received encrypted data using its private key, and sends the decrypted data back to the dispenser system 705 (step 830). The dispenser system validates the received data by comparing it with its original generated data (step 835). If the received data is validated, the dispenser system 705 sends a message to the POS system 720 indicating that it is a trusted system, and that the dispenser system 705 will accept and process POS commands from the POS system 720 (step 840)

In addition, the same authentication procedure can be performed before each customer transaction starts. For example, after a customer begins a transaction at the dispenser system 705 (step 845), the dispenser system 705 generates random or pseudo-random data (step 850) and encrypts the generated data using the public key associated with the POS system 720 (step 855). The dispenser system 705 sends the encrypted data to the POS system 720 (step 860). The POS system 720 decrypts the encrypted data using its private key (step 865), and sends the decrypted data back to the dispenser system 705 (step 870). The dispenser system validates the received data by comparing it with its original generated data (step 875). If the received data is validated, the dispenser system 705 sends a message to the POS system 720 indicating that the normal transaction using the remote network host 735 can begin (step 880).

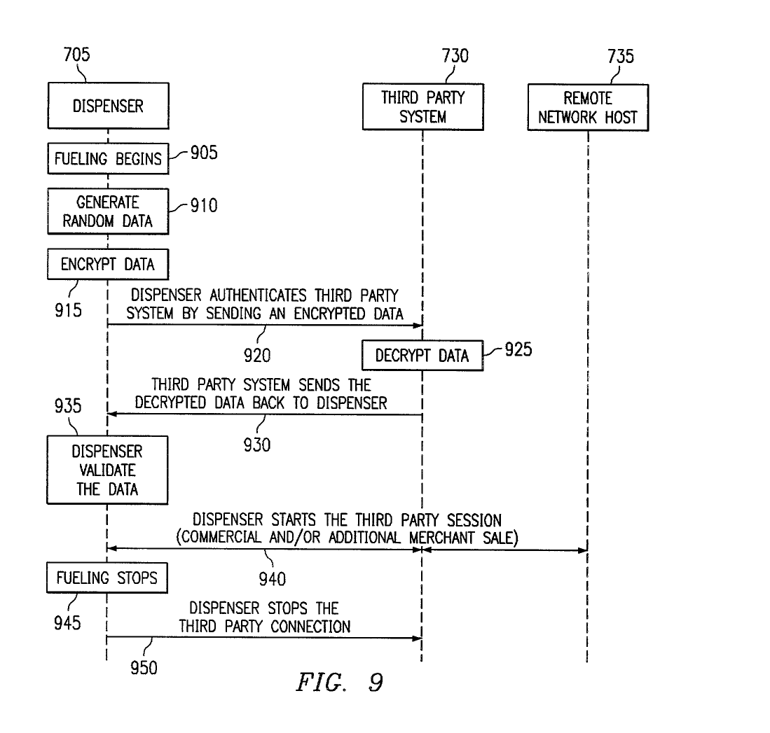

Referring now to FIG. 9, there is illustrated a method for providing a secured third party transaction in accordance with the secured data communication system 700 of FIG. 7. In step 905, a fueling operation is initiated by a customer at the dispenser system 705 which includes a third party transaction. The dispenser system 705 generates random or pseudo-random data based upon the current time, time related data, or other unique data that cannot be predicated (step 910) and encrypts the generated data using the public key associated with the third party system 730 (step 915). The dispenser system 705 sends the encrypted data to the third party system 730 for authentication (step 920) In step 925, the third party system 730 decrypts the encrypted data using its private key, and sends the decrypted data back to the dispenser system 705 (step 930).

The dispenser system 705 validates the received data by comparing it with its original generated data (step 935). If the received data is validated, the dispenser system 705 sends a message to the third party system 730 indicating that the third party session using the remote network host 735 for authentication can begin (step 940), allowing the sending of advertisement-type contents or additional merchant sales. Once the fueling operation stops (step 945), the dispenser system 705 sends a message to the third party system 730 to end the connection to the third party system 730 (step 950).

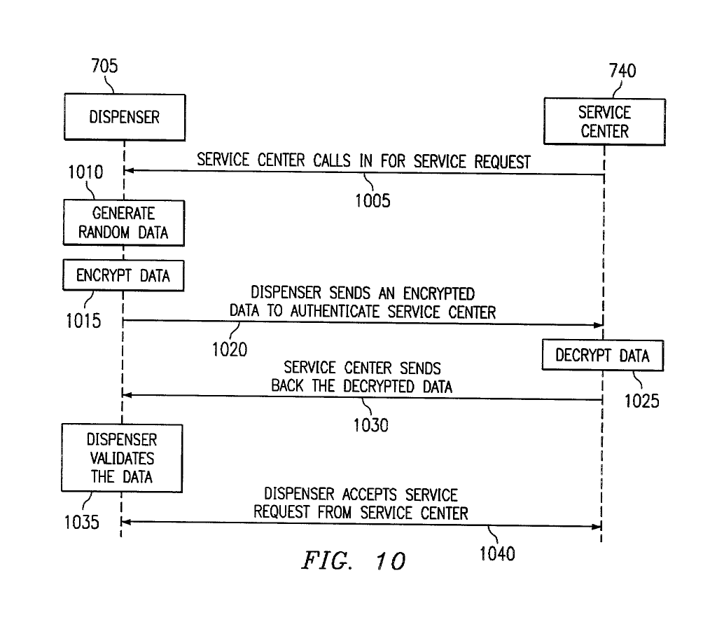

Referring now to FIG. 10, there is illustrated a method for providing secured service in accordance with the secured data communication system 700 of FIG. 7. In step 1005, a local or remote service center 740 sends a service center request to the dispenser system 705. Upon receiving the service center request, the dispenser system 705 generates random or pseudo-random data based upon the current time, time related data, or other unique data that cannot be predicted (step 1010). The dispenser system 705, encrypts the generated data using a public key associated with the service center 740 (step 1015), and sends the encrypted data to the service center 740 for authentication (step 1020).

Upon receipt of the encrypted data, the service center 740 decrypts the data using its private key (step 1025), and sends the decrypted data back to the dispenser system 705 (step 1030). After receiving the decrypted data, the dispenser system 705 validates the received data by comparing it with its original generated data (step 1035). If the received data is validated, the dispenser system considers the service center 740 as a trusted system, and accepts and processes service commands from the service center 740 (step 1040).

Although various embodiments of the method and system of the present invention have been illustrated in the accompanying Drawings and described in the foregoing Detailed Description, it will be understood that the invention is not limited to the embodiments disclosed, but is capable of numerous rearrangements, modifications and substitutions without departing from the scope of the invention as set forth and defined by the following claims.

What is claimed is:

1. A system for secure communication within a fueling environment, comprising:
a fuel dispenser system for receiving user card data, encrypting the user card data using a public cryptography key, and transmitting the encrypted user card data; and
a network host for receiving the encrypted user card data and decrypting the encrypted user card data using a private cryptography key associated with the public cryptography key.

2. The system of claim 1, further comprising:
a point-of-sale (POS) system for receiving the encrypted user card data from the fuel dispenser system, and forwarding the encrypted user card data to the network host.

3. The system of claim 2, wherein the network host validates the decrypted user card data and transmits a card data authorization message to the point-of-sale system.

4. The system of claim 3, further comprising:
a pump controller, wherein the point-of-sale system receives the card data authorization message and transmits a pump authorization message to the pump controller.

5. The system of claim 1, wherein the fuel dispenser system further comprises a customer access terminal (CAT) for receiving the user card data.

6. The system of claim 1:
wherein the network host is adapted to:
select a new private cryptography key;
select a new public cryptography key associated with the new private cryptography key;
encrypt the new public cryptography key using the previous private cryptography key to produce an encrypted message; and
transmit the encrypted message to the fuel dispenser system; and
wherein the fuel dispenser system is adapted to receive the encrypted message and decrypt the encrypted message using the previous public cryptography key to obtain the new public cryptography key; and
whereby further encrypted communication between the fuel dispenser system and the network host is performed using the new private cryptography key and the new public cryptography key.

7. A system for secure communication within a fueling environment, comprising:
a point-of-sale system associated with a fuel dispenser for receiving user card data, encrypting the user card data using a public cryptography key, and transmitting the encrypted user card data; and
a network host for receiving the encrypted user card data and decrypting the encrypted user card data using a private cryptography key associated with the public cryptography key.

8. The system of claim 7, wherein the wherein the network host validates the decrypted user card data and transmits a card data authorization message to the point-of-sale system.

9. The system of claim 8, wherein the point-of-sale system receives the card data authorization message and transmits a pump authorization message to a pump controller.

10. The system of claim 7:
wherein the network host is adapted to:
select a new private cryptography key;
select a new public cryptography key associated with the new private cryptography key;
encrypt the new public cryptography key using the previous private cryptography key to produce an encrypted message; and
transmit the encrypted message to the point-of-sale system; and
wherein the point-of-sale system is adapted to receive the encrypted message and decrypt the encrypted message using the previous public cryptography key to obtain the new public cryptography key; and
whereby further encrypted communication between the point-of-sale system and the network host is performed using the new private cryptography key and the new public cryptography key.

11. A system for secure communication within a fueling environment, comprising:
a fuel dispenser system for receiving user card data, encrypting the user card data using a public cryptography key, and transmitting the encrypted user card data;
a third party system for receiving and forwarding the encrypted user card data; and
a network host for receiving the encrypted user card data from the third party system and decrypting the encrypted user card data using a private cryptography key associated with the public cryptography key.

12. The system of claim 11, wherein the network host validates the decrypted user card data and transmits a card data authorization message to the third party system.

13. The system of claim 11, wherein the third party system is adapted to transmit a sale solicitation message to the fuel dispenser system.

14. The system of claim 11:
wherein the network host is adapted to:
select a new private cryptography key;
select a new public cryptography key associated with the new private cryptography key;
encrypt the new public cryptography key using the previous private cryptography key to produce an encrypted message; and
transmit the encrypted message to the fuel dispenser system; and
wherein the fuel dispenser system is adapted to receive the encrypted message and decrypt the encrypted message using the previous public cryptography key to obtain the new public cryptography key; and
whereby further encrypted communication between the fuel dispenser system and the network host is performed using the new private cryptography key and the new public cryptography key.

15. A system for secure communication within a fueling environment, comprising:
a fuel dispenser system for receiving user card data, encrypting the user card data using a point-of-sale public cryptography key, and transmitting the encrypted user card data; and
a point-of-sale system for receiving the encrypted user card data and decrypting the encrypted user card data using a private cryptography key associated with the point-of-sale public cryptography key.

16. The system of claim 15, wherein the point-of-sale system forwards the decrypted user card data to a network host for validation of the user card data.

17. The system of claim 16, wherein the network host transmits a user card data authorization message to the point-of-sale system in response to the validation of the user card data.

18. The system of claim 17, wherein the point-of-sale system transmits a pump authorization message to a pump computer in response to receiving the user card data authorization message.

19. The system of claim 15:
wherein the point-of-sale system is adapted to:
select a new private cryptography key;
select a new public cryptography key associated with the new private cryptography key;
encrypt the new public cryptography key using the previous private cryptography key to produce an encrypted message; and
transmit the encrypted message to the fuel dispenser system; and
wherein the fuel dispenser system is adapted to receive the encrypted message and decrypt the encrypted message using the previous public cryptography key to obtain the new public cryptography key; and
whereby further encrypted communication between the fuel dispenser system and the network host is performed using the new private cryptography key and the new public cryptography key.

20. A system for secure communication and control within a fueling environment, comprising:
a point-of-sale system for transmitting a pump configuration command;
a fuel dispenser system for receiving the pump configuration command, generating pseudo-random data in response to the pump configuration command, encrypting the generated pseudo-random data using a public cryptography key, and transmitting the encrypted generated pseudo-random data to the point-of-sale system.

21. The system of claim 20, wherein the point-of-sale system is adapted to receive the encrypted generated pseudo-random data from the point-of-sale system, decrypt the encrypted generated pseudo-random data using a private cryptography key associated with the public cryptography key, and transmit the decrypted pseudo-random data to the fuel dispenser system.

22. The system of claim 21, wherein the fuel dispenser system is adapted to receive the decrypted data from the point-of-sale system, validate the decrypted data, and process the pump configuration command from the point-of-sale system if the decrypted data is valid.

23. The system of claim 21:
wherein the point-of-sale system is adapted to:
select a new private cryptography key;
select a new public cryptography key associated with the new private cryptography key;
encrypt the new public cryptography key using the previous private cryptography key to produce an encrypted message; and
transmit the encrypted message to the fuel dispenser system; and
wherein the fuel dispenser system is adapted to receive the encrypted message and decrypt the encrypted message using the previous public cryptography key to obtain the new public cryptography key; and
whereby further encrypted communication between the fuel dispenser system and the point-of-sale system is performed using the new private cryptography key and the new public cryptography key.

24. A system for secure communication and control within a fueling environment, comprising:
a fuel dispenser system for generating pseudo-random data in response to the initiation of a fueling session, encrypting the generated pseudo-random data using a public cryptography key, and transmitting the encrypted generated pseudo-random data; and
a third party system for receiving the encrypted generated pseudo-random data, decrypting the encrypting generated pseudo-random data using a private cryptography key associated with the public cryptography key, and transmitting the decrypted pseudo-random data to the fuel dispenser system.

25. The system of claim 24, wherein the fuel dispenser system is adapted to validate the decrypted data and start a third party session if the decrypted data is valid.

26. The system of claim 24:
wherein the third party system is adapted to:
select a new private cryptography key;
select a new public cryptography key associated with the new private cryptography key;
encrypt the new public cryptography key using the previous private cryptography key to produce an encrypted message; and
transmit the encrypted message to the fuel dispenser system; and
wherein the fuel dispenser system is adapted to receive the encrypted message and decrypt the encrypted message using the previous public cryptography key to obtain the new public cryptography key; and
whereby further encrypted communication between the third party system and the fuel dispenser system is performed using the new private cryptography key and the new public cryptography key.

27. A system for secure communication and control within a fueling environment, comprising:
a service center for transmitting a service center request; and
a fuel dispenser system for receiving the service center request from the service center, generating pseudo-random data in response to the service center request, encrypting the generated pseudo-random data using a public cryptography key, and transmitting the encrypted generated pseudo-random data to the service center.

28. The system of claim 27, wherein the service center is adapted to receive the encrypted generated pseudo-random data from the fuel dispenser system, decrypt the encrypted generated pseudo-random data using a private cryptography key associated with the public cryptography key, and transmit the decrypted pseudo-random data to the fuel dispenser system.

29. The system of claim 28, wherein the fuel dispenser system is adapted to validate the decrypted pseudo-random data and process the service request from the service center if the decrypted pseudo-random data is valid.

30. The system of claim 28:
wherein the service center is adapted to:
select a new private cryptography key;
select a new public cryptography key associated with the new private cryptography key;
encrypt the new public cryptography key using the previous private cryptography key to produce an encrypted message; and
transmit the encrypted message to the fuel dispenser system; and
wherein the fuel dispenser system is adapted to receive the encrypted message and decrypt the encrypted message using the previous public cryptography key to obtain the new public cryptography key; and
whereby further encrypted communication between the fuel dispenser system and the service center is performed using the new private cryptography key and the new public cryptography key.

31. A system for secure communication within a fueling environment, comprising:
a first node associated with a fuel dispenser for receiving user data, encrypting the user data using a public cryptography key, and transmitting the encrypted user data;
a second node for receiving the encrypted user data and decrypting the encrypted user data using a private cryptography key associated with the public cryptography key.

32. The system of claim 31, wherein the first node comprises a customer access terminal (CAT).

33. The system of claim 31, wherein the first node comprises a point-of-sale (POS) system.

34. The system of claim 31, wherein the second node comprises a network host.

35. The system of claim 31, wherein the second node comprises a point-of-sale (POS) system.

36. The system of claim 31, further comprising:
a third node for receiving the encrypted user data from the first node, and forwarding the encrypted user data to the second node.

37. The system of claim 36, wherein the third node comprises a point-of-sale system.

38. The system of claim 36, wherein the third node comprises a third party system.

39. The system of claim 31, wherein the second node validates the decrypted user data and transmits a user data authorization message to the first node.

40. The system of claim 39, wherein the first node transmits a pump authorization message to a pump computer in response to receiving the user data authorization message.

41. The system of claim 36, wherein the second node validates the decrypted user data and transmits a user data authorization message to the third node.

42. The system of claim 41, wherein the second node transmits a pump authorization message to a pump computer in response to receiving the user data authorization message.

43. The system of claim 31:
wherein the second node is adapted to:
select a new private cryptography key;
select a new public cryptography key associated with the new private cryptography key;
encrypt the new public cryptography key using the previous private cryptography key to produce an encrypted message; and
transmit the encrypted message to the first node; and
wherein the first node is adapted to receive the encrypted message and decrypt the encrypted message using the previous public cryptography key to obtain the new public cryptography key; and
whereby further encrypted communication between the first node and the second node is performed using the new private cryptography key and the new public cryptography key.

44. A system for secure communication and control within a fueling environment, comprising:
a first node associated with a fuel dispenser for receiving a first message, generating pseudo-random data in response to the first message, encrypting the generated pseudo-random data using a public cryptography key, and transmitting the encrypted generated pseudo-random data;
a second node for receiving the encrypted generated pseudo-random data from the first node, decrypting the encrypted generated pseudo-random data using a private cryptography key associated with the public cryptography key, and transmitting the decrypted generated pseudo-random data to the first node; and
wherein the first node is further adapted to receive the decrypted generated pseudo-random data from the second node, validate the decrypted generated pseudo-random data, and process the first message if the decrypted generated pseudo-random data is valid.

45. The system of claim 44, wherein the first message is transmitted by the second node.

46. The system of claim 45, wherein the second node comprises a point-of-sale system, and the first message comprises a pump configuration command.

47. The system of claim 45, wherein the second node comprises a service center, and the first message comprises a service center request.

48. The system of claim 44, wherein the first message comprises a fueling operation initiation message.

49. The system of claim 44:
wherein the second node is adapted to:
select a new private cryptography key;
select a new public cryptography key associated with the new private cryptography key;
encrypt the new public cryptography key using the previous private cryptography key to produce an encrypted message; and
transmit the encrypted message to the first node; and
wherein the first node is further adapted to receive the encrypted message and decrypt the encrypted message using the previous public cryptography key to obtain the new public cryptography key; and
whereby further encrypted communication between the first node and the second node is performed using the new private cryptography key and the new public cryptography key.

50. A method for secure communication within a fueling environment, comprising the steps of:
receiving user data at a first node associated with a fuel dispenser;
encrypting the user data using a public cryptography key;
transmitting the encrypted user data;
receiving the encrypted user data at a second node; and
decrypting the encrypted user data using a private cryptography key associated with the public cryptography key.

51. The method of claim 50, further comprising the steps of:
receiving, at a third node, the encrypted user data from the first node; and
forwarding the encrypted user data to the second node.

52. The method of claim 50, further comprising the steps of:
validating the decrypted user data; and
transmitting a user data authorization message.

53. The method of claim 52, further comprising the steps of:
receiving the user data authorization message; and
transmitting a pump authorization message to a pump computer in response to receiving the user data authorization message.

54. The method of claim 50, further comprising the steps of:
selecting, by the second node, a new private cryptography key;
selecting, by the second node, a new public cryptography key associated with the new private cryptography key;
encrypting the new public cryptography key using the previous private cryptography key to produce an encrypted message;
transmitting the encrypted message to the first node; and
receiving, at the first node, the encrypted message and decrypting the encrypted message using the previous public cryptography key to obtain the new public cryptography key; and
whereby further encrypted communication between the first node and the second node is performed using the new private cryptography key and the new public cryptography key.

55. A method for secure communication and control within a fueling environment, comprising the steps of:
receiving a first message at a first node associated with a fuel dispenser;
generating pseudo-random data in response to the first message;
encrypting the generated pseudo-random data using a public cryptography key;
transmitting the encrypted generated pseudo-random data to a second node;
receiving, at the second node, the encrypted generated pseudo-random data;
decrypting the encrypted generated pseudo-random data using a private cryptography key associated with the public cryptography key;
transmitting the decrypted generated pseudo-random data to the first node;
receiving, at the first node, the decrypted generated pseudo-random data;
validating the decrypted generated pseudo-random data; and
processing the first message if the decrypted generated pseudo-random data is valid.

56. The method of claim 55, wherein the first message is transmitted by the second node.

57. The method of claim 55, wherein the first message is a pump configuration command.

58. The method of claim 55, wherein the first message is a fueling operation initiation message.

59. The method of claim 55, wherein the first message is a service center request.

60. The method of claim 55, further comprising the steps of:
selecting, by the second node, a new private cryptography key;
selecting, by the second node, a new public cryptography key associated with the new private cryptography key;
encrypting the new public cryptography key using the previous private cryptography key to produce an encrypted message;
transmitting the encrypted message to the first node; and
receiving, at the first node, the encrypted message and decrypting the encrypted message using the previous public cryptography key to obtain the new public cryptography key; and
whereby further encrypted communication between the first node and the second node is performed using the new private cryptography key and the new public cryptography key.
